(19) United States
(12) Patent Application Publication
(10) Pub. No.: US 2025/0144772 A1
(43) Pub. Date: May 8, 2025

(54) DUAL-SPEED TIGHTENING/UNTIGHTENING DEVICE WITH FLOATING RING GEAR

(71) Applicant: ETABLISSEMENTS GEORGES RENAULT, SAINT HERBLAIN (FR)

(72) Inventors: Paul POUPLARD, NANTES (FR); Benjamin BARBAUD, SAINT HERBLAIN (FR); Loïc MICHEL, SAFFRE (FR)

(21) Appl. No.: 18/938,765

(22) Filed: Nov. 6, 2024

(30) Foreign Application Priority Data
Nov. 7, 2023 (FR) 2312052

(51) Int. Cl. B25B 21/00; B25B 23/14; B25B 23/147; B25F 5/00

(52) U.S. Cl. CPC B25B 21/008; B25B 23/141; B25B 23/147; B25F 5/001

(57) ABSTRACT

A tightening device including a transmission having an engageable/disengageable additional gear train. The additional gear train includes an epicyclic train with a toothed inner ring gear. The device includes engagement elements for engaging the additional gear train, able to take at least an engaged state and a disengaged state. A speed reducing ratio of the transmission is different depending on whether the additional gear train is engaged. The ring gear is mobile in translation along an axis of a rotor inside a casing of the device between: a free position, when the engaging elements are in the disengaged state and the ring gear is mobile in rotation relative to the casing so the additional gear train is disengaged; and a locked position, when the engaging element are in the engaged state and the ring gear is locked in rotation relative to the casing so the additional gear train is engaged.

### 1. CROSS-REFERENCE TO RELATED APPLICATION

The present application claims priority to French Application No. FR 2312052, filed Nov. 7, 2023, the content of which is hereby incorporated by reference in its entirety.

### 2. FIELD OF THE DISCLOSURE

The field of the disclosure is that of designing and manufacturing hand-held tools intended to be implemented for performing screwing/unscrewing operations

More specifically, the disclosure relates to a tightening/untightening device offering several tightening/untightening speeds. This device is more particularly designed for continuous tightening machines whose torque exceeds 150 N.m (high-torque screwing machines).

### 3. PRIOR ART

Tightening devices are commonly used in various industrial sectors to perform tightening and/or untightening operations on assemblies.

A tightening operation generally comprises two successive phases, namely:
a preliminary tightening phase during which the element to be tightened is driven at high speed until a certain level of preliminary tightening torque is reached, then
a slower tightening phase until a target tightening torque and/or a target tightening angle are reached.

Electric motor tightening devices are typically associated with control means motor controller) and comprise a tightening torque and/or tightening angle sensor.

These control means enable tightening strategies to be programmed, that is the parameters of the preliminary tightening and tightening phases, in particular the rotation speeds of the motor during the preliminary tightening and tightening phases, as well as the end-of-tightening target torque and/or angle values. Thus, while a tightening operation is performed, the control means control the motor to drive the element to be tightened at the preliminary tightening speed during the preliminary tightening phase, then at the tightening speed during the tightening phase until the target torque and/or angle are reached.

Continuous tightening machines, that is tightening machines that during tightening apply to the screw an uninterrupted and increasing torque, incorporate a transmission between the motor and the output member driving the screw. This transmission generally consists of one or more epicyclic trains. These epicyclic trains allow for sufficient tightening torque to be available on the output shaft. This torque is the result of multiplying the motor torque by the speed reducing ratio of the transmission and its efficiency.

To be able to achieve high tightening torques, for example greater than 150 N.m, tightening machine manufacturers need to have a high speed reducing ratio by having several epicyclic trains in the transmission. This has the disadvantage that the rotation frequency of the tightening machine output shaft becomes relatively low, resulting in a long tightening time that hampers productivity.

Thus, high-torque tightening machine manufacturers have come up with the idea of having a device incorporated into the transmission to disengage one of the epicyclic trains during preliminary tightening. The speed reducing ratio implemented during preliminary tightening becomes therefore lower than during torque rise during tightening, with the advantage of a high rotation frequency during preliminary tightening and a high torque during torque rise during tightening. This epicyclic train, which may be engaged or disengaged, is referred to as an additional train.

The preliminary tightening and tightening speeds applied during the preliminary tightening and tightening phases therefore require the implementation of an additional gear train that can be engaged and disengaged to define different speed reducing ratios between the rotor and the output member depending on whether or not it is engaged. Thus, the additional gear train is not engaged during the preliminary tightening phase, so that the preliminary tightening speed is high. Conversely, the additional train is engaged during the tightening phase so that the tightening speed is lower and the tightening torque the tightening device can achieve is higher.

The additional gear train is automatically engaged mechanically at the end of the preliminary tightening phase. To this end, in the state of the art solutions, the transmission incorporates an elastic element that automatically engages the additional gear train when the tightening torque reaches a predetermined speed change torque threshold during the preliminary tightening phase.

This type of mechanism is advantageous in that it enables tightening speed to be changed automatically, in a simple and effective way. However, this type of technology can still be improved.

Indeed, in the solutions described in the state of the art, the predetermined speed change tightening torque threshold above which the additional train engages automatically cannot be parameterised as it depends on the dimensioning of the elastic element incorporated into the transmission. As a result, this type of technology does not provide versatile tightening machines that can be adapted to various tightening operations requiring a change of speed after reaching various values of preliminary tightening threshold.

To overcome this disadvantage, the Filing party has developed a technique for selecting the moment when the additional train is engaged so as to adapt this engagement to the needs of the tightening operation to be performed.

The patent document EP-A1-4 205 907, filed on behalf of the Filing party, describes in this sense a technique for engaging an additional train, independently of the tightening torque, by acting solely on the acceleration level of the motor.

Such a solution therefore represents a major improvement of the solutions previously described in the prior art.

The solutions described in this patent document are particularly effective. However, they can still be improved.

### 4. SUMMARY

For this purpose, an aspect of the disclosure proposes a tightening device comprising:
a casing;
a motor with a rotor;
an output member that may drive in rotation a drive element of an element to be tightened;
a transmission connecting said rotor to said output member, said transmission comprising at least one additional gear train that may be engaged/disengaged, said at least one additional gear train comprising at least one epicyclic train with a toothed inner ring gear;
   said device comprising means for engaging said at least one additional gear train, said means for engaging being able to take at least:
an engaged state in which the at least one additional gear train is engaged, and
a disengaged state in which said at least one additional gear train is not engaged, the speed reducing ratio of said transmission between said rotor and said output member being different depending on whether or not said additional gear train is engaged.

According to an aspect of the disclosure, said ring gear is mounted so as to be mobile in translation along the axis of said rotor inside said casing between at least:
a free position, taken when said means for engaging are in said disengaged state, and in which said ring gear is mobile in rotation relative to said casing in such a way that said at least one additional gear train is disengaged, and
a locked position, taken when said means for engaging are in said engaged state, and in which said ring gear is locked in rotation relative to said casing in such a way that said at least one additional gear train is engaged.

Thus, an aspect of the disclosure proposes a tightening and/or untightening device for engaging/disengaging in particular a simple additional gear train, with a reduced number of parts, whose mechanism for engaging/disengaging the additional gear train can be easily incorporated into the tool.

According to one possible characteristic, a tightening device according to the disclosure comprises means for controlling said motor, said means for controlling said motor being configured to generate a predetermined acceleration or deceleration of said rotor, said predetermined acceleration or deceleration acting on said means for engaging to switch them from one of their states to the other.

An aspect of the disclosure thus provides a tightening device in which an additional train is engaged independently of the tightening torque and depending on the acceleration of the motor.

According to one possible characteristic, said inner toothed ring gear comprises a first locking portion and said casing comprises a second locking portion, said first and second locking portions being complementary to each other and shaped to ensure locking in rotation of said ring gear relative to said casing when they cooperate with each other, said first and second locking portions cooperating with each other in said locked position of said ring gear and not cooperating with each other in said free position of said ring gear.

According to one possible characteristic, said first and second locking portions are tapered in shape.

According to one possible characteristic, a tightening device according to the disclosure comprises elastic return means acting on said ring gear to tend to maintain it in said locked position.

According to one possible characteristic, said means for engaging comprise means for driving in translation said ring gear from one of its locked and free positions to the other, said means for driving being configured to transform a rotation of said rotor in a translation of said ring gear consecutively to generation of said acceleration or deceleration by said means for controlling said motor.

According to one possible characteristic, a tightening device according to the disclosure comprises means for driving in translation said ring gear from one of its locked and free positions to the other, said means for driving in translation comprising at least one cam path formed on said ring gear and at least one locking member connected in rotation to said rotor, said at least one locking member being mobile between at least:
an inactive position in which said locking member is not in contact with said cam path so that a rotation of said rotor relative to said ring gear does not induce a translation of said ring gear, and
an active position in which said locking member is in contact with said cam path so that a rotation of said rotor relative to said ring gear induces a translation of said ring gear along the axis of said rotor.

According to one possible characteristic, said at least one locking member, when it is in said active position, is configured to move against said cam path, during a relative rotation movement of said rotor relative to said ring gear, between:
a first end position in which said ring gear is in said free position, and
a second end position in which said ring gear is in said locked position.

According to one possible characteristic, a tightening device according to the disclosure comprises means for connection in rotation said ring gear and said rotor, said means for connection in rotation comprising said at least one locking member and at least one element forming a stop integral with said ring gear, said element forming a stop being arranged in such a way that said locking member is in contact with said element forming a stop when said locking member is in said active position and in said first end position.

According to one possible characteristic, said cam path comprises a shape capable of at least partially housing said locking member when it is in its first end position, said shape being configured to maintain said locking member reversibly in said first end position.

According to one possible characteristic, said means for engaging comprise a selection member mobile in rotation relative to said rotor between at least:
a position for engaging said additional gear train, and
a position for disengaging said additional gear train,
   said selection member acting on said at least one locking member to:
in said engaged position, place said locking member in its inactive position;
in said disengaged position, place said locking member in its active position.

According to one possible characteristic, said selection member comprises a cam surface in contact with said locking member, said cam surface acting on said locking member to allow its movement from one of its active and inactive positions to the other.

According to one possible characteristic, said locking member is kept in contact with said cam surface by elastic return means, said elastic return means acting on said locking member to tend to move it towards its active position.

According to one possible characteristic, said locking member is mobile in translation between its active and inactive positions along an axis orthogonal to the rotation axis of said rotor.

According to one possible characteristic, a tightening device according to the disclosure comprises a support element connected in rotation to said rotor, said at least one locking member being integral in rotation with said support element and mounted so as to be mobile relative to it between its active and inactive positions, said selection member being mounted so as to be mobile in rotation relative to said support element between its engaged and disengaged positions, said support element comprising stop elements with which stop elements of said selection member may come in contact, said stop elements defining said engaged and disengaged positions of said selection member.

### 5. DESCRIPTION OF THE FIGURES

Other characteristics and advantages of the disclosure will emerge upon reading the following description of particular embodiments, provided as a simple illustrative non-restrictive example, and the annexed drawings, wherein:

FIG. 1 illustrates a longitudinal partial cross-section view of a device according to an aspect of the disclosure with the additional train engaged;

FIG. 2 illustrates a detailed view of FIG. 1;

FIGS. 3 and 4 illustrate two views of a ring gear of the device of FIGS. 1 and 2;

FIGS. 5 and 6 illustrate two views of a selection member of the device of FIGS. 1 and 2;

FIG. 7 illustrates a longitudinal partial cross-section view of a device according to an aspect of the disclosure with the additional train engaged;

FIG. 8 illustrates a cross-section along the B-B axis of FIG. 7;

FIG. 9 illustrates a cross-section along the A-A axis of FIG. 7;

FIG. 10 illustrates a longitudinal partial cross-section view of a device according to an aspect of the disclosure with the additional train disengaged;

FIG. 11 illustrates a cross-section along the B-B axis of FIG. 10;

FIG. 12 illustrates a cross-section along the A-A axis of FIG. 10;

FIG. 13 illustrates a detailed view of the device of FIG. 1 in an intermediate state between engagement and disengagement;

FIG. 14 illustrates a detailed view of FIG. 13;

FIG. 15 illustrates a longitudinal cross-section view of a device according to an aspect of the disclosure.

### 6. DESCRIPTION OF PARTICULAR EMBODIMENTS

### 6.1. Architecture

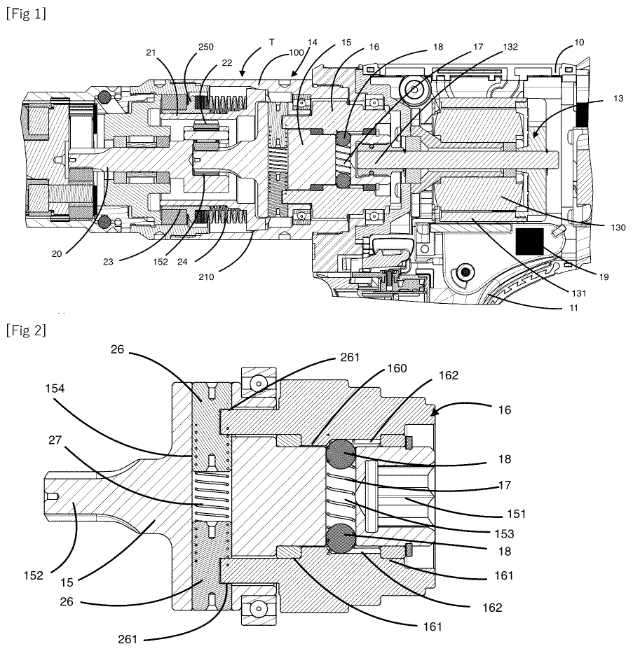

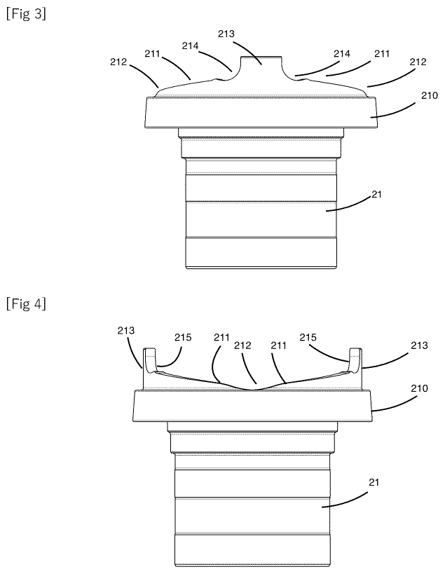

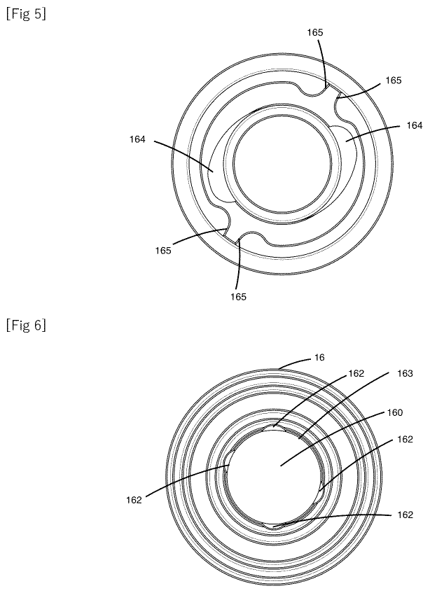

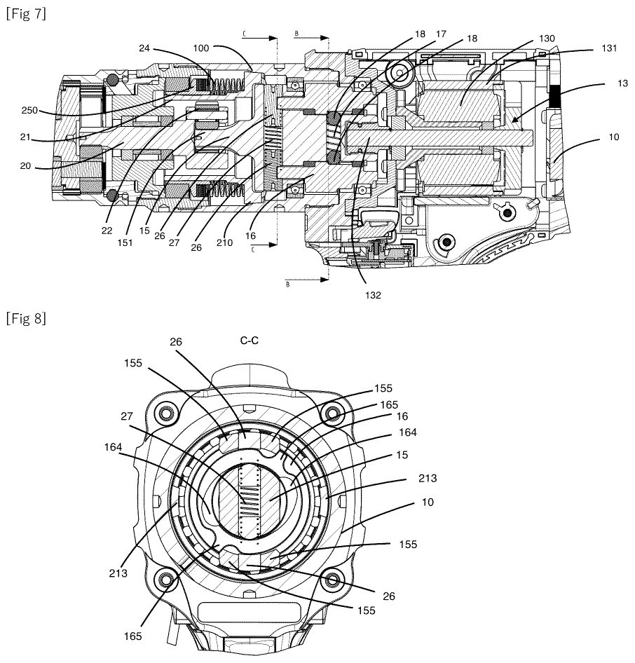

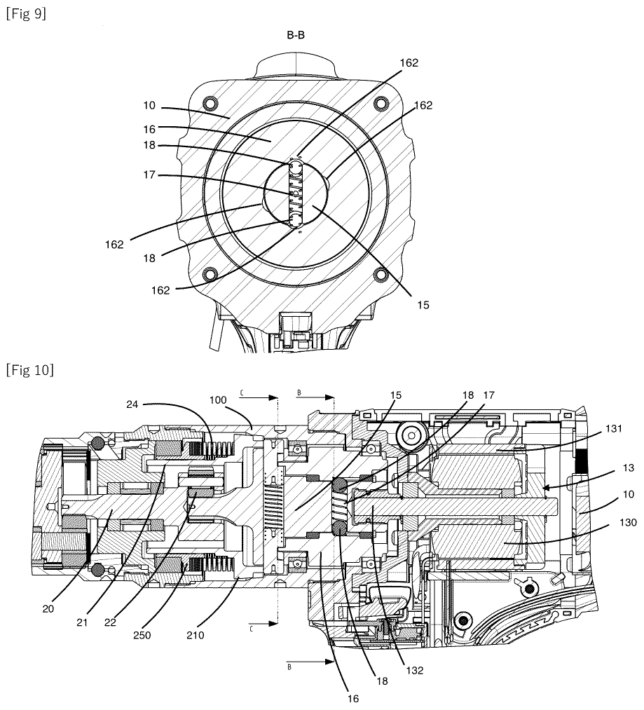

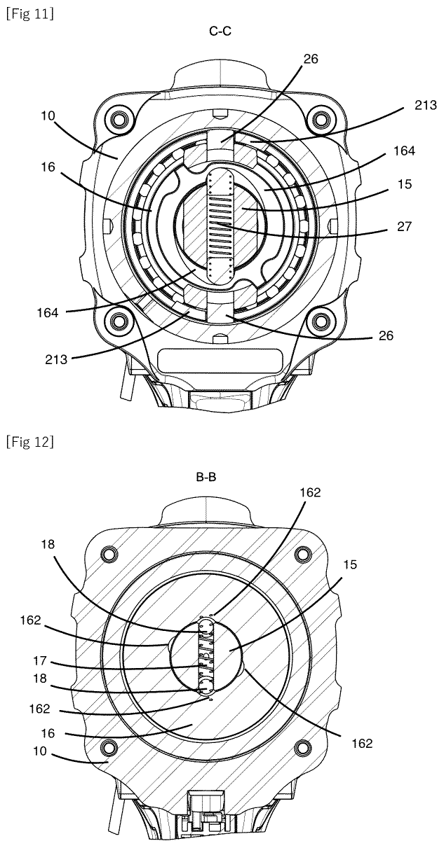

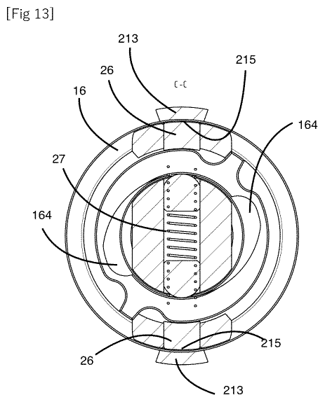

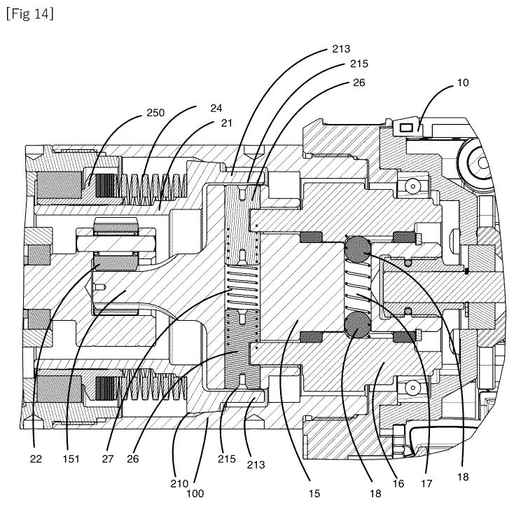

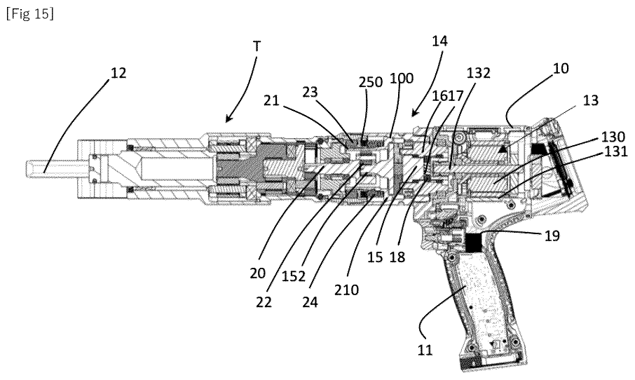

One embodiment of a tightening device according to an aspect of the disclosure is presented in relation to FIGS. 1 to 15.

Such a tightening device can be used to perform tightening and/or untightening operations.

As shown, such a tightening and/or untightening device typically comprises a casing 10. Here, it is a pistol grip casing in which the axis of the grip 11 forms an angle with the axis of the output member 12. It could alternatively be a casing in which the axis of the grip coincides with the axis of the output member.

The casing 10 houses an electric motor 13 comprising a stator 130 and a rotor 131 fitted with a motor shaft 132. In this embodiment, the rotor is external. In variants, it can be internal.

The device comprises an output member 12 located at the end of the casing 10. This output member 12 may drive in rotation a drive element of an element to be screwed, in particular a drive socket or similar.

The device comprises a transmission T connecting the shaft 132 of the rotor 131 to the output member 12 so as to drive the latter in rotation.

The transmission T comprises a dual-speed mechanism 14 that comprises two transmission chains having different transmission ratios. To do this, the transmission T comprises an additional gear train that may be engaged/disengaged. As will be described in more detail later, this additional train comprises here an epicyclic train that can be disengaged by making its toothed inner ring gear free in rotation or engaged by locking its ring gear in rotation.

The dual-speed mechanism 14 comprises means for engaging the additional gear train, these means being able to take at least:
an engaged state in which the additional train is engaged, and
a disengaged state in which the additional gear train is disengaged.

The speed reducing ratio of the transmission between the rotor and the output member is different depending on whether or not the additional gear train is engaged, the speed reducing ratio here being higher when the additional gear train is engaged. In variants, the speed reducing ratio can be higher when the additional gear train is engaged. In this way, for a given rotation frequency of the rotor, the rotation frequency of the output member is higher when the additional gear train is not engaged and lower when it is engaged, so that the torque that may be delivered by the device is higher when the additional gear train is engaged.

The means for engaging comprise a support element 15. This support element 15 is mounted so as to be mobile in rotation in the casing 10 along the axis of the rotor 131. At one of its ends, it is integral with the motor shaft 132 in such a way that it is connected in rotation to the rotor 131. The assembly of the support element 15 and the motor shaft 132 can be performed by means of splines 151. At the other of its ends, it comprises a sun gear 152. In a variant, the motor shaft 132 and the support element 15 could form a single piece.

The means for engaging comprise a selection member 16. This selection member 16 is mounted so as to be mobile in rotation along the axis of the rotor 131 on the support element 15, for example by means of plain bearings or bearings 161, between at least two end positions, namely:
a position for engaging the additional gear train, and
a position for disengaging the additional gear train.

In each of these two end positions, the selection member 16 is connected in rotation to the support element 15 by means for connection in rotation. To this end, the support element 15 has a transverse hole 153 arranged along an axis perpendicular to its longitudinal axis. This hole 153 houses elastic return means that comprise in this embodiment a compression spring 17. A locking element is placed at each end of the compression spring 17. In this embodiment, these locking elements are realised by means of locking balls 18.

The selection member 16 is crossed by an inner bore 160 housing the support element 15. Two pairs of diametrically opposed locking housings 162 are arranged at the periphery of the inner bore 160. The locking housings 162 of each pair are connected by a peripheral groove 163.

The locking balls 18 are mobile along an axis orthogonal to the axis of the support element 15, against the effect of the elastic return means 17, between at least:
a position for connection in rotation in which the balls 18 are housed in two of the diametrically opposed locking housings 162 so that the support element 15 and the selection member 16 are connected in rotation, and
a release position in which the balls 18 are not housed in any of the locking housings 162, but are in the groove 163, so that the support element 15 and the selection member 16 are not connected in rotation.

When the selection member 16 is in its position for engaging the additional gear train, the locking balls 18 are housed in two first of the opposing housings 162. When the selection member 16 is in its position for disengaging the additional gear train, the balls 18 are in two other of the opposing housings 162.

When the balls 18 are in their position for locking in rotation, the means for connecting in rotation the support element 15 to the selection member 16 are capable of transmitting a predetermined limit torque Cl, beyond which the balls pass switch to their release position, in which the support element and the selection member are no longer connected in rotation and can no longer transmit torque. This predetermined torque depends in particular on the stiffness of the spring 17, the size of the balls 18, the geometry of the locking housings 162 and the groove 163. This torque can typically be determined by calculation or empirically.

The device typically comprises means for measuring the tightening torque delivered by the device at the output member. These measuring means can, for example, comprise a torque sensor placed in the transmission between the rotor and the output member, or a sensor for the current consumed by the motor.

The device typically comprises means for controlling 19 the motor. These means are used to control the motor, in particular by controlling its power supply. They can be totally or partially located inside or outside the casing.

By acting on the acceleration/deceleration of the rotor 131 of the motor 13, the means for controlling 19 the motor make it possible to switch the means for engaging from one of their states to the other, i.e. to switch the selection member 16 from one of its positions to the other relative to the support element 15.

For the means for engaging to switch from one of their positions to the other, the acceleration/deceleration generated by the motor must be greater than the quotient of the limit torque Cl that can be transmitted by the means for connection in rotation by the inertia Jos of the selection member along its rotation axis. This acceleration/deceleration is referred to as speed change acceleration/deceleration as it enables to engage/disengage the additional gear train and thus to change the speed reducing ratio of the transmission between the rotor and the output member.

While a tightening/untightening operation is performed, the motor typically produces accelerations and variations in acceleration, particularly during starting up. Therefore, the acceleration/deceleration that induces the switching of the engaging means from one of their states to the other has to be sufficiently discriminating, i.e. far from, and more precisely greater than, the accelerations that typically may occur, for example during start up or stop, so as not to cause unintentional switching of the selection means from one of their states to the other.

The transmission comprises an epicyclic train comprising the sun gear 152 integral in rotation with the support element 15, a planet carrier 20 integral in rotation with the output member 12, and an inner toothed ring gear 21 meshing with planet gears 22 carried by the planet carrier 20. In variants, the planet carrier can be connected in rotation to the input of another epicyclic train or a cascade of epicyclic trains, whose output will be connected in rotation to the output member 12.

The ring gear 21 is mounted so as to be mobile in rotation inside the casing by means of a bearing 23.

The ring gear 21 has at one of its ends a frustoconical shaped locking portion 210.

The casing 10 has a frustoconical locking portion 100.

The locking portions 210 and 100 are complementary in shape and designed to cooperate with each other.

The ring gear 21 is mounted so as to be mobile in translation inside the casing 10 along the axis of the rotor 131 between at least:
a free position, taken when the means for engaging are in the disengaged state, and in which the ring gear 21 is mobile in rotation relative to the casing in such a way that the additional gear train is disengaged: in this position, the locking portions 210 and 100 are distant from each other;
a locked position, taken when the means for engaging are in the engaged state, and in which the ring gear 21 is locked in rotation relative to the casing 10 in such a way that the additional gear train is engaged: in this position, the locking portions 210 and 100 are in contact with each other to lock the ring gear 210 in rotation relative to the casing 10.

A compression spring 24 is interposed between a bearing surface 250 of a base 25 in which the ring gear 21 is mounted so as to be mobile in translation between its two end positions. This compression spring 24 acts on the ring gear 21 to tend to maintain it in its locked position.

The ring gear 21 has, at one of its ends, a two pairs of cam paths 211.

Each cam path 211 has an inclined surface thickening from a recess 212 towards the end of the ring gear 21 facing the support element 15. An element forming a stop 213 is arranged at the thicker end of each cam path 211. The connection area between each cam path 211 and each element forming a stop 213 comprises a shape 214.

The support element 15 is crossed by a transverse bore 154. This bore 154 houses two locking members 26 mounted so as to slide in the bore 154 and in a diametrically opposite way.

A compression spring 27 is interposed in the bore 154 between the two locking members 26 and tends to move them apart from each other.

Each locking member 26 is mobile in translation in the bore 154 between at least:
an inactive position in which the locking member 26 goes into the bore 154 so that it is not in contact with the cam path 211 of the ring gear 21 in such a way that a rotation of the rotor 131 relative to the ring gear 21 does not induce a translation of the ring gear 21, and
an active position in which the locking member 26 is deployed outside the bore 154 so that it is in contact with the cam path 211 of the ring gear 21 in such a way that a rotation of the rotor 131 relative to the ring gear 21 induces a translation of the ring gear 21 along the axis of the rotor 131.

The locking members 26, when they are in their active position, are configured to move against the cam path 211 of the ring gear 21, during a relative rotation movement of the rotor 131 relative to the ring gear, between:
a first end position in which the ring gear is in its free position; the locking members 26 are then in contact with the stops 213 in the shapes 214;
a second end position in which the ring gear is in its locked position; the locking members 26 are then located in the recesses 212.

The selection member 16 may act on the locking members 26 to:
in its engaged position, place said locking members in their inactive position;
in its disengaged position, place said locking members in their active position.

Each locking member 26 comprises a guiding housing 261 arranged laterally.

At its end facing the locking members 26, the selection member 16 has cam surfaces 164 shaped to interact with the guiding housings 261 of the locking members 26 by being housed therein. These cam surfaces 164 have a thin end from which it tends to extend radially to a thicker end.

These cam surfaces may act on the locking members to release their movement from their inactive position to their active position and to induce their movement from their active position to their inactive position.

The locking members are kept in contact with the cam surfaces by the spring 27, this spring 27 acting on the locking members to tend to move them towards their active position.

The selection member 16 comprises diametrically opposed stop elements 165 designed to come in contact with stop elements 155 arranged for this purpose on the support element 15. These stops 165, 155 define the engaged and disengaged positions of the selection member 16. As will appear more clearly when reading the description of the operation of a device according to an aspect of the disclosure, these stops make it possible to stop the rotation of the selection member 16 relative to the support element 15 without using the locking members 26. This protects the locking elements from shocks when the selection member 16 reaches its engaged and disengaged positions.

The elements forming a stop 213 of the ring gear 21 are arranged in such a way that the locking members 26 are in contact with these elements forming a stop 213 and are housed in the shapes 214 when the locking members 26 are in their active position and in their first end position.

The cam paths of the ring gear and the locking members ensure the ring gear is driven in translation by transforming a rotation movement of the support element into a translation movement of the ring gear.

In other words, as it will be more clearly understood later reading the operation of a device according to an aspect of the disclosure, the means for driving in translation the ring gear from one of its locked and free positions to the other are configured to transform a rotation of the rotor in a translation of the ring gear consecutively to generation of the acceleration or deceleration by the means for controlling the motor.

The stops of the ring gear and the locking devices ensure that the ring gear is connected in rotation to the rotor.

The shapes 214 of the ring gear 21 are capable of housing at least partially the locking member when it is in its first active position, this shape being configured to maintain the locking member reversibly in the first end position.

In variants, one or more permanent, i.e. non-disengageable, gear trains, for example epicyclic, can be arranged between the planet carrier 20 and the output member 12.

When the additional gear train is disengaged, the speed reducing ratio of the transmission is equal to 1 as the support element 15 and the planet carrier 20 rotate at the same rotation frequency, or to the speed reducing ratio of the permanent gear train or to their product if several permanent trains are implemented.

When the additional gear train is engaged, the speed reducing ratio of the transmission is equal to the speed reducing ratio of the additional epicyclic train, or to its product with the speed reducing ratio(s) of the permanent gear train(s) implemented, if any.

### 6.2. Operation

A tightening operation comprising a high-speed preliminary tightening phase followed by a lower speed tightening phase is described below

Before starting a tightening/untightening operation, the operator in charge of it programs in the controller, for example by means of a touch screen, a keyboard, a smartphone or similar, the value of the predetermined speed change torque threshold TSpeedChange that, when reached at the output of the tightening device during a preliminary tightening phase, triggers a speed change and a switch to the tightening phase. Alternatively, this speed change torque can be calculated automatically by the tool depending on the desired target tightening torque, rather than being set by the operator. This speed change torque can be a percentage of the target tightening torque. This percentage can be set by the operator or predefined in the tool.

The operator can also program the value of the target torque at which they want the assembly to be tightened at the end of the tightening phase.

It is assumed that the tightening device has previously been used to perform a tightening operation comprising a rapid preliminary tightening phase and a slower tightening phase. The additional train is thus engaged.

When the tightening device is started up in order to perform such a tightening/untightening operation, the control means control the motor in such a way that it generates, in the tightening or untightening direction, a speed change acceleration \dot{w} whose value is greater than the quotient of the predetermined limit torque Cl(\dot{w}>Cl/Jos), beyond which the balls 18 switch to their release position in which the support element 15 and the selection member 16 are no longer connected in rotation, by the inertia Jos of the selection member. The balls then leave the pair of locking housings 162 corresponding to the position for engaging the selection member 16 to be housed in the other pair of locking housings 162 corresponding to the position for disengaging the selection member 16. In this way, the means for engaging the additional gear train are placed in their disengaged state. The control means then control the motor so as to rotate in the tightening direction to disengage the additional gear and perform the preliminary tightening phase.

When the means for engaging are in the state for disengaging the additional gear train, the selection member 16 is in its disengaged position, in which it is held by the balls 18 which are in the corresponding locking housings 161, its stops 165 being in contact with the stops 155 of the support element 15.

The cam surfaces 164 of the selection member 16 act on the locking members 26 so as to release their movement into their active position in which they are placed and held under the effect of the spring 27. The cam surfaces 164 therefore do not move the locking members 26 into their active position. This prevents any locking of the system when switching from the engaged state to the disengaged state. Indeed, during this switch, it is possible that when the locking members 26 are released and pushed by the spring 27 towards their active position, their end lines up with the inner surface 215 of the stops 213 of the ring gear 21. If the locking members 26 were at this moment pushed by the cam surfaces 164, they would come in contact with these inner surfaces 215 and lock the rotation of the moving parts. Because the cam surfaces 164 only release, i.e. make possible, their move into their active position under the effect of the spring 17, once they no longer line up with the inner surfaces 215, the spring places the locking members 26 in their active position.

A rotation of the motor induces a movement of the locking members 26 against the cam paths 211 of the ring gear 21, inducing a movement of the ring gear 21 in translation, against the effect of the compression spring 24, from its locked position to its free position, which is reached when the locking members 26 abut against the stops 213 of the ring gear. They are then housed in the shapes 214 that maintain them in position.

In this state, the motor shaft 132 rotates the support element 15 and the locking members 26, which in turn rotate the ring gear 21 at the speed of the motor shaft 132.

The ring gear 21 rotates the solar gear 151 via the satellites 22. The sun gear and the ring gear 21 then rotate at the same speed, which forces the satellite carrier 20 to rotate at the same speed too. The output member 12 therefore rotates at the same speed as the motor. Thus, the output member 12 is driven in rotation in the tightening direction at high speed.

The control means control the motor in such a way that the output member is driven in rotation at high speed during the preliminary tightening phase until the tightening torque delivered by the tightening device reaches the predetermined speed change torque threshold TSpeedChange.

When the control means detect by means of the torque sensor that this threshold has been reached, the control means brake the motor in order to generate a speed change deceleration whose value is greater than the quotient of the limit torque Cl predetermined by the inertia Jos of the selection member. In this way, the selection means are moved to their state for engaging the additional gear train.

When this deceleration is generated, the balls 18 leave their housings 162 to move in the groove 163 until they are housed in the other locking housings 162 of the selection member 16. In doing so, the selection member 16 rotates relative to the support element 15 so as to occupy its engaged position in which its stops 165 are in contact with the stops 155 of the support element 15.

During this movement of the selection member 16, its cam surfaces 164 act on the locking members 26 so as to return them to their inactive position. As they move from their active position to their inactive position, the locking members 26 move along the cam paths 211 of the ring gear 21 until they reach their thinnest end and are housed in the recesses 212, so that the ring gear gradually translates from its free position to its locked position in which it is kept immobile in rotation relative to the casing.

The control means then control the motor so that it reaches its rated rotation frequency while generating however an acceleration \dot{w} lower than the speed change acceleration in order to ensure that the selection means remain in their state for engaging the additional gear train; in other words, the acceleration \dot{w} must be such that \dot{w}<Cl/Jos. The control means then control the motor so as to rotate in the tightening direction to perform the lower speed tightening phase.

In the state for engaging the additional gear train, when the rotor rotates in the tightening direction, the output member 12 is driven in rotation at a different speed from that of the motor insofar as the satellite carrier 20 rotates at a different speed from that of the motor since the ring gear is no longer free in rotation but is lock in rotation in the casing.

Thus, the control means control the motor until they detect, by means of the torque sensor, that the target tightening torque at which the assembly being screwed should be tightened has been reached.

The torque sensor can be a current measurement. It may be considered to cause the additional train to engage/disengage on the basis of a reason other than the torque measurement, for example a time measurement.

Any other reason for switching from high speed/low torque to low speed/high torque (and vice versa) can be considered. This can be done automatically (reaching a torque, a time, etc.) or at the operator's request (pressing a button, etc.).

When the target torque is reached, the control means brake the motor, preferably with a deceleration lower than the speed change deceleration, until the rotation frequency of the motor becomes zero. However, braking with greater deceleration would have no effect given that the sliding torque of the selection member 16 relative to the support element 16 is substantially greater when the balls no longer have the opportunity to move to a groove 163.

If the motor rotates at the same frequency during the rapid preliminary tightening and slow tightening phases, the difference in speed of the output member is due to the fact that during the preliminary tightening phase, the ring gear is free to rotate, whereas during the tightening phase, it is prevented from rotating. In other words, the additional gear train is disengaged during the preliminary tightening phase but engaged during the tightening phase. Thus, the transmission chains solicited during these two phases have different transmission ratios.

In this embodiment, the motor rotates counter-clockwise for a tightening operation and clockwise for an tightening operation when viewed from the output member towards the rear of the tightening machine. These directions could be reversed.

If an acceleration is required to switch the selection means from their state for disengaging the additional gear train to their state for engaging the additional gear train, a deceleration will be necessary to switch from their state for disengaging the additional gear train to their state for engaging the additional gear train and vice versa.

An exemplary embodiment of the present disclosure notably provides an effective solution to at least some of these various problems.

In particular, at least one embodiment improves tightening devices ensuring an additional gear train is engaged/disengaged.

In particular, at least one embodiment provides such a tightening device in which an additional train is engaged independently of the tightening torque and depending on the acceleration of the motor.

Another purpose, at least one embodiment provides such a tightening device in a simplified form.

In particular, at least one embodiment simplifies the way in which the ring gear of the additional epicyclic train can be locked/unlocked in rotation relative to the casing of the tightening device to engage/disengage the additional gear train could be simplified.

At least one embodiment reduces the number of components implemented.

At least one embodiment provides a solution that can be easily incorporated into various tightening/untightening devices.

At least one embodiment provides a solution that is reliable and/or robust and/or cost-effective.

Although the present disclosure has been described with reference to one or more examples, workers skilled in the art will recognize that changes may be made in form and detail without departing from the scope of the disclosure and/or the appended claims.

What is claimed is:

1. A tightening device comprising:
a casing;
a motor with a rotor;
an output member that is drivable in rotation to drive a drive element of an element to be tightened;
a transmission connecting said rotor to said output member, said transmission comprising at least one additional gear train that can be engaged/disengaged, said at least one additional gear train comprising at least one epicyclic train with a toothed inner ring gear; and
engaging elements for engaging said at least one additional gear train, said engaging elements being able to take at least:
an engaged state in which the at least one additional gear train is engaged, and
a disengaged state in which said at least one additional gear train is not engaged,
a speed reducing ratio of said transmission between said rotor and said output member being different depending on whether or not said additional gear train is engaged, and
wherein said ring gear is mounted so as to be mobile in translation along the axis of said rotor inside said casing between at least:
a free position, taken when said engaging elements is in said disengaged state, and in which said ring gear is mobile in rotation relative to said casing in such a way that said at least one additional gear train is disengaged, and
a locked position, taken when said engaging elements are in said engaged state, and in which said ring gear is locked in rotation relative to said casing in such a way that said at least one additional gear train is engaged.

2. The tightening device according to claim 1 comprising a motor controller for controlling said motor, said motor controller being configured to generate a predetermined speed change acceleration or deceleration of said rotor, said predetermined speed change acceleration or deceleration acting on said engaging elements to switch them from one of their states to the other.

3. The tightening device according to claim 1 wherein said inner toothed ring gear comprises a first locking portion and said casing comprises a second locking portion, said first and second locking portions being complementary to each other and shaped to ensure locking in rotation of said ring gear relative to said casing when they cooperate with each other, said first and second locking portions cooperating with each other in said locked position of said crown and not cooperating with each other in said free position of said ring gear.

4. The tightening device according to claim 3 wherein said first and second locking portions are tapered in shape.

5. The tightening device according to claim 1 comprising an elastic return acting on said ring gear to tend to maintain the ring gear in said locked position.

6. The tightening device according to claim 1 comprising a translator for driving in translation said ring gear from one of the locked and free positions to the other, said translator comprising at least one cam path formed on said ring gear and at least one locking member connected in rotation to said rotor, said at least one locking member being mobile between at least:
an inactive position in which said locking member is not in contact with said cam path so that a rotation of said rotor relative to said ring gear does not induce a translation of said ring gear, and
an active position in which said locking member is in contact with said cam path so that a rotation of said rotor relative to said ring gear induces a translation of said ring gear along the axis of said rotor.

7. The tightening device according to claim 6 wherein said at least one locking member, when in said active position, is configured to move against said cam path, during a relative rotation movement of said rotor relative to said ring gear, between:
a first end position in which said ring gear is in said free position, and
a second end position in which said ring gear is in said locked position.

8. The tightening device according to claim 7 comprising a rotational connection for connecting in rotation said ring gear and said rotor, said rotational connection comprising said at least one locking member and at least one element forming a stop integral with said ring gear, said element forming a stop being arranged in such a way that said locking member is in contact with said element forming a stop when said locking member is in said active position and in said first end position.

9. The tightening device according to claim 7 wherein said cam path comprises a shape capable of at least partially housing said locking member when in the first end position, said shape being configured to maintain said locking member reversibly in said first end position.

10. The tightening device according to claim 6 wherein said engaging elements comprises a selection member mobile in rotation relative to said rotor between at least:
a position for engaging said additional gear train, and
a position for disengaging said additional gear train,
said selection member acting on said at least one locking member to:
in said engaged position, place said locking member in its inactive position;
in said disengaged position, place said locking member in its active position.

11. The tightening device according to claim 10 wherein said selection member comprises a cam surface in contact with said locking member, said cam surface acting on said locking member to allow movement from one of the active and inactive positions to the other.

12. The tightening device according to claim 11 wherein said locking member is kept in contact with said cam surface by an elastic return, said elastic return acting on said locking member to tend to move the locking member towards the active position.

13. The tightening device according to claim 6 wherein said locking member is mobile in translation between the active and inactive positions along an axis orthogonal to the rotation axis of said rotor.

14. The tightening device according to claim 11 comprising a support element connected in rotation to said rotor, said at least one locking member being integral in rotation with said support element and mounted so as to be mobile relative to said support element between its active and inactive positions, said selection member being mounted so as to be mobile in rotation relative to said support element between the engaged and disengaged positions, said support element comprising stop elements with which stop elements of said selection member can come in contact, said stop elements defining said engaged and disengaged positions of said selection member.
